(19) United States
(12) Patent Application Publication
(10) Pub. No.: US 2002/0107887 A1
(43) Pub. Date: Aug. 8, 2002

(54) Method for compressing character-based markup language files

(76) Inventor: Robert E. Cousins, Saratoga, CA (US)

Correspondence Address: LAW OFFICE OF THOMAS SCHNECK, P.O. BOX 2-E, SAN JOSE, CA, 95109-0005, US

(21) Appl. No.: 09/777,401

(22) Filed: Feb. 6, 2001

(51) Int. Cl. G06F 17/22; G06F 17/24

(52) U.S. Cl. 707/513; 707/530

(57) ABSTRACT

A method for compressing character-based markup language files in a web document prior to compression of the entire web document. The method first includes converting the tags and the attributes of the tags to a single case format. Then, the attributes are placed in a specified order within the tags in order to make the tags more uniform and to enable larger strings of common text to be found. Finally, any unnecessary white spaces and end-of-line characters are eliminated to decrease the size of the file. The document that results from the method of the invention will compress more efficiently, yet the content is semantically identical to its original form.

### TECHNICAL FIELD

The present invention relates to communications between a client and a server in a computer network environment. More particularly, the invention relates to compression of communication data files written in a character-based markup language.

### BACKGROUND ART

The Internet has made a voluminous amount of documents stored on computers around the world readily available to anyone having a computer, a modem, a phone line and some kind of browser software. However, though the documents are readily available through the Internet, the documents are not always transmitted to the user as quickly as desired. Modems and telephones have limited bandwidth and large documents require much more transmission time. As the number of Internet users has increased, the amount of volume of information transferred has increased, pushing the limits at which networks can provide information in an adequate time frame. Additionally, although one can increase the speed of data retrieval by increasing the amount of bandwidth that one has, this is not desirable as increasing bandwidth is costly. Therefore, it is desirable to increase the speed at which data files are transmitted in order to keep up with the growing demand for information from users of the Internet, but without having to increase bandwidth.

In order to achieve this desire to increase the speed of the information transmission without increasing bandwidth, techniques have been developed to compress the data files. Many of these techniques have been published in the RFC standards and are well known in the art. For example, the GZIP compression algorithm, described in RFC1952, is a common file compression method. Other known file compression methods include the ZLIB Compressed Data Format Specification (RFC1950) and the DEFLATE Compressed Data Format Specification (RFC1951).

The documents found on the Internet are usually written in some kind of character-based markup language, such as HTML, XML, or SGML. For example, HTML (HyperText Markup Language) is a popular language used for writing web pages. In HTML, each document is divided into two main parts, a heading and a body. The heading contains information to identify the page, while the body contains the actual information to be displayed. Tags are used to tell the browser which part of the page corresponds to the heading and which part corresponds to the body. The tags are placed between marker characters (typically “<” and “>”) and are usually used in pairs, with one of the pair used to start a section and the other used to close it. A browser does not display the tags for the user to see, but rather the tags merely control the way the browser displays the output. The HTML language uses a free-format input, which allows for the HTML to include arbitrary spaces, called “white spaces”, between words and to allow extra lines to be inserted, moved or eliminated at will. Other characteristics of the tags include the fact that the tags are case insensitive, which means that the command has the same meaning whether it is in capital or lowercase letters. Also, the first word in the tag specifies the type of tag, while arguments are space delimited and in no specific order. Some tags use the same attributes or arguments as other tags, such that within a document, similar tags and argument strings are common.

Another type of markup language is XML, which was designed especially for Web documents. XML allows web designers to create their own customized tags, enabling the definition, transmission, validation, and interpretation of data between applications and between organizations.

As noted, there is quite a bit of extra, unnecessary space used within the markup language files. It would be desirable to be able to use the characteristics of the various markup languages in order to compress the tags and other markup language files prior to using the standard compression methods, such as GZIP, to compress the entire file. By precompressing the markup language files, the overall web document file can be further reduced such that the speed at which the file is transmitted will increase, without any increase in bandwidth.

It is an object of the present invention to provide a method of compressing character-based markup language files that uses the characteristics of the markup language to make the files more uniform, and thus easier to compress.

It is a further object of the invention to provide a method of compressing character-based markup language files prior to compressing the entire web document file in order to make the web document file more compact and, thus, increase the speed of transmission of the file.

### SUMMARY OF THE INVENTION

The above objects have been achieved in a method for compressing character-based markup language files in which the tags are converted to a single case format and then the attributes of the tags are placed in a specified order within the tags in order to make the tags more uniform. This order enables larger strings of common text to be found. Finally, any unnecessary white spaces and end-of-line characters are eliminated to decrease the size of the file. The document that results from the method of the invention will compress more efficiently, yet the content is semantically identical to its original form. The method of the present invention is intended to be used in conjunction with the GZIP compression algorithm, or other similar known compression algorithms, in order to further increase the compression of the overall file, and thus increase the speed at which the file can be transmitted.

### BRIEF DESCRIPTION OF THE DRAWINGS

FIG. 1 is a diagram of a typical HTML web document as is known in the art.

FIG. 2 is a flow diagram of the method of the present invention.

### BEST MODE FOR CARRYING OUT THE INVENTION

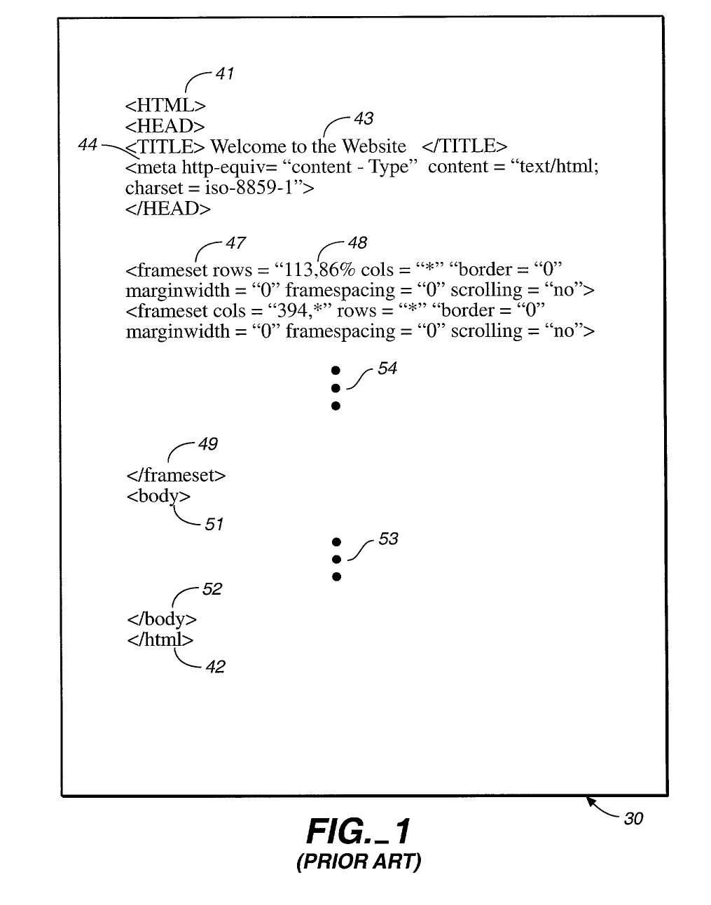

For explanatory purposes, FIG. 1 shows a typical example of a web document 30 written in the HTML markup language. As explained above, the tags such as the HTML tags 41, 42 and the body tags 51, 52 are placed between marker characters and are usually arranged in pairs, with one of the pair used to start a section and the other to close it. Some kind of text 43 can be arranged between the tags. For example, between the TITLE tags 44, 46 there is some text 43 that states the title of the web site, “Welcome to the Web Site”. The markup file 30 also includes a meta tag 44 which contains information that search engines use to locate the web document. Within the tags are attributes 47 and arguments 48. An attribute is a characteristic about a tag or a data field, while an argument is a parameter or value of the attribute. For example, the attribute 47 specifies a characteristic about the frameset tag and the argument 48 indicates the parameters of the attribute 47. In FIG. 1, the stacked dots 54 indicate that additional frameset characteristics may be added to the web page 30. This information is still part of the heading and is not displayed for the user to see. The stacked dots 53 represent a plurality of text that is included between the two body tags 51, 52. This text is the text that the user would see displayed on the web page.

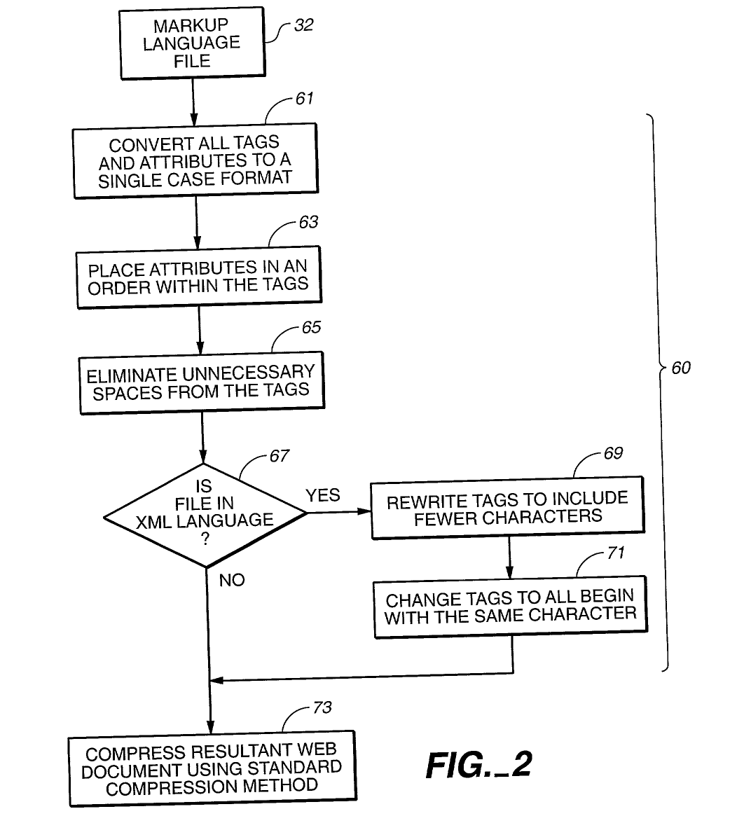

With reference to FIG. 2, the method of the present invention is practiced on a markup language file 32, similar to that which is described with reference to FIG. 1. The method of the present invention 60 precompresses the markup language in the file prior to a subsequent overall compression of the web document file, such that the resultant file is more compressed and, thus, easier to transmit. The method 60 of the present invention starts with, step 61, converting all of the tags, including the attributes within the tags, to a single case format. As discussed, the tags of the markup language are case insensitive. Therefore “<table>” and “<TABLE>” are semantically identical. By converting all of the tags to be in either all lower case letters or all upper case letters, the possible number of combinations necessary for the compression algorithm to evaluate is reduced. The next step, step 63, is to place all of the attributes in an order within the tags such that longer strings of common text may be found. For example, the attributes could be alphabetized such that strings of common text would be next to each other and would be easier to combine. Additionally, redundant attributes could be combined. For example, in FIG. 1, the attributes “frame spacing”, “marginwidth”, and “scrolling”, are used more than once. By arranging these attributes so that the attributes are easily combined together, the compressibility of the file is increased.

Referring back to FIG. 2, the next step, step 65, is to eliminate unnecessary spaces from the tags. In HTML, as well as in other markup languages, there are quite a bit of white spaces and end-of-line characters that can be eliminated from within the tags. With rare exception, white spaces and end-of-line characters are not important and can be moved and/or eliminated at will. Eliminating these unnecessary spaces from the tags will help to compress the file even further before the final compression algorithm is implemented.

In the method of the present invention, if the file is in an XML language, step 67, then additional steps may be taken to even further compress the file. The XML language, short for “extensible markup language”, allows designers to create their own customized tags. Therefore, the next step, step 69, is to rewrite the tags to include fewer characters. For example, this could involve using single letter characters to represent the attributes, such as replacing the “body” tag with simply “B”, and the “frameset” tag with “F”. Since the designer can use whatever name he or she wants for identifying the tags, by using very short attributes, this further helps to make the file easier to compress. The next step, step 71, is to change all the tags to begin with the same character. This is similar to the previous step, step 63, of placing all of the attributes in an alphabetical order in order to make it easier to find common groups of text to compress. However, since the designer can define the tags in which ever way he or she wishes, by having all of the tags begin with the same letter, this makes it even easier to compress. For example, one could replace the “title” tag with “A”, the “body” tag with “AA”, and the “head” tag with “AAA”. This would allow for easier compression than keeping the original tag names, “title”, “body” and “head”. This completes the method 60 of the present invention. After the markup language files have been precompressed, using the method 60 of the present invention, then, step 73, the resultant web document is compressed using standard compression methods. This compression can be done with any of the standard RFC published compression algorithms, however, in the preferred embodiment of the method the present invention is used in conjunction with the GZIP file format specification, RFC 1952.

By compressing the markup language files using the method of the present invention, one can obtain approximately 15% to 20% reduction in the size of the file. Then, one can achieve an additional 5 to 10% reduction in the size of the file following the use of the GZIP or an other standard compression method to compress the resultant web document file. The method of the present invention does not change the content of the file, and allows the file to be compressed even further than the file would have been had only the standard compression methods been used. This allows for increased speed in the transmission of the web document file.

1. A method for compressing character-based markup language files, said markup language files including a text having a plurality of tags, and said tags including a plurality of attributes and arguments, the method comprising:
converting said tags and said attributes into a single case format;
placing said attributes in an order within said tags, said order enabling larger strings of common text to be found; and
eliminating a plurality of spaces from within said tags.

2. The method of claim 1, further defined by using a compression algorithm to compress a web document that includes the markup language files.

3. The method of claim 2, wherein the compression algorithm is GZIP.

4. The method of claim 1, wherein the plurality of spaces includes extra white spaces.

5. The method of claim 1, wherein the plurality of spaces includes end-of-line characters.

6. The method of claim 1, wherein the step of placing said attributes in an order includes placing the attributes in an alphabetical order.

7. The method of claim 1, wherein the markup language is HTML language.

8. The method of claim 1, wherein the markup language is XML language.

9. The method of claim 8, further comprising:
rewriting the tags to include fewer characters; and
changing the tags to have all of the tags begin with a same character.

10. The method of claim 1, wherein the markup language is SGML language.

11. The method of claim 1, wherein the single case format consists of uppercase text.

12. The method of claim 1, wherein the single case format consists of lowercase text.

13. A method for compressing character-based markup language files, said markup language files including a text having a plurality of tags, and said tags including a plurality of attributes and arguments, the method comprising:
converting said tags and said attributes into a single case format;
placing said attributes in an alphabetical order within said tags, said alphabetical order enabling larger strings of common text to be found;
combining redundant attributes within said tags; and
eliminating a plurality of spaces from within said tags.

14. The method of claim 13, wherein the method is used in conjunction with a compression algorithm to compress a web document that includes the markup language files.

15. The method of claim 13, wherein the plurality of spaces includes extra white spaces.

16. The method of claim 13, wherein the plurality of spaces includes end-of-line characters.

17. The method of claim 1, wherein the markup language is HTML language.

18. The method of claim 1, wherein the markup language is XML language.

19. The method of claim 18, further comprising rewriting the tags to include fewer characters.

20. The method of claim 18, further comprising changing the tags to have all of the tags begin with a same character.

21. The method of claim 1, wherein the single case format consists of lowercase text.

22. A method for compressing a web document having a plurality of character-based markup language files, each of said markup language files including a text having a plurality of tags, and said tags including a plurality of attributes and arguments, the method comprising:
converting said tags and attributes of each of said markup language files into a single case format;
placing said attributes in an alphabetical order within said tags, said alphabetical order enabling larger strings of common text to be found;
combining redundant attributes within said tags;
eliminating a plurality of spaces from within said tags; and
compressing a resultant web document including a plurality of precompressed markup language files using a standard compression algorithm.
